(19) United States
(12) Patent Application Publication
(10) Pub. No.: US 2010/0083238 A1
(43) Pub. Date: Apr. 1, 2010

(54) Binary manipulation of intermediate-language code

(75) Inventors: Michael Barnett, Redmond, WA (US); Michael C. Fanning, Redmond, WA (US); Brian M. Grunkemeyer, Redmond, WA (US); Barend H. Venter, Issaquah, WA (US)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/242,691

(22) Filed: Sep. 30, 2008

(51) Int. Cl. G06F 9/45

(52) U.S. Cl. 717/136

(57) ABSTRACT

One or more embodiments, described herein, are directed towards a technology for performing transformations and/or modifications to managed byte code. In order to perform the transformations and/or modifications, a mutable programmable representation (MPR) is laid out. A programmer then performs an arbitrary adjustment using the MPR.

### BACKGROUND

A compiler is a computer program primarily used for converting source code of a high-level programming language into a low-level language or a machine language. Source code is understood to be a set of programming instructions written in a high-level programming language. Examples of high-level programming languages include FORTRAN, C, C++, PASCAL, Ada, BASIC, COBOL, LISP, and Prolog.

Typically, compared to low-level programming languages, high-level programming languages are easier to use for programmers because they utilize an artificial language that is machine independent and has its own semantics that must be enforced on any particular machine's architecture by the compiler. By design, a high-level programming language isolates the execution semantics of computer architecture from the specification of a written program. This makes the process of developing a program simpler and more understandable for the human programmer than it would be if a low-level language was employed. In other words, a programmer can more easily understand and modify a high-level programming language.

Low-level programming languages, on the other hand, provide little or no abstraction from a particular computer's microprocessor. The word “low” refers to the small or nonexistent amount of abstraction between the programming language and machine language. Because of this, low-level programming languages are sometimes described as being “close to the hardware.”

Conventionally, a compiler generates a low-level programming language from source code in a relatively straightforward sequence of conventional transformations. For example, a compiler may transform the source code into object code.

Object code is a representation of compact code containing “binaries” that a compiler generates from source code. Object code represents an intermediary form between the source code and the machine code (which is ultimately what is executed by a computer).

Examples of some conventional transformations that a compiler may perform include (for example and not by limitation): construction of parse trees from source code, analysis of basic blocks, control- and data-flow analysis, optimizations and code generation.

As programmers began developing and writing larger computer programs in source code to be compiled by one or more compilers, virtual memory systems began to appear. The virtual memory systems helped account for the increase in size of the computer programs developed by the programmers. As a result, compilation became more complicated, typically devolving into two distinct stages. First, the source code was separated into discrete modules and compiled according to the discrete modules, instead of compiling the program as a whole. These discrete modules could then be reused, on a module-by-module basis, in other compilation contexts. Second, these discrete modules were combined with one another into executable binaries to be executed on a computer. Executable binaries refer to one or more files of object code linked together to run an executable application at the machine level.

As compilation became more complicated with the development of larger programs, compiler performance began to support trends towards further development of high-level programming languages. These high-level programming languages produced bodies of reusable code and additional metadata, associated with the reusable code, utilized to enable new tooling, such as debuggers.

Eventually, the increased complexity of computer operating systems prompted advances in operating system (OS) loaders, which began to behave, in part, like linkers. Linkers help fix references to shared code, thereby reducing the memory pressure. Complexities around threading, memory management and the proliferation of operating systems prompted investments in the development of supporting managed runtime activities. Managed runtime activities include loading and linking of classes needed to execute a program, optional machine code generation and dynamic optimization of the program, and actual program execution.

Several previous concerns associated with computer programming, such as memory management, code verification, and machine code generation, that used to be within the domain of either a programmer, a front-end, a back-end or an OS loader were pushed into the domain of managed runtime activities. As a result, compilers began to transform source code into intermediate representations, which could be interpreted by virtual machines running on varying operating systems.

Eventually, an actual machine code generation step known as just-in-time (JIT) compilation was introduced in order to improve execution speed across varying operating systems. Throughout the process of JIT compilation, intermediate code, a low-level programming language, and other metadata became increasingly rich, consistent, predictable, and available. Thus, using metadata in association with the intermediate code, a programmer had an array of new and more powerful tools and functionality.

However, because the intermediate code is a low-level programming language, a human programmer is unlikely to be able to read, understand, and analyze this “close to the hardware” data. Even to make a simple manipulation, modification or transformation, a programmer would much rather go back to source code (which is in a high-level language) than take such action with the intermediate code. However, implementing such changes to the source code requires a recompilation of one or more programs and probably a re-linking as well.

However, in the context of larger, more complicated computer programs developed by one or more programs, the process of returning to the source code in order to implement a manipulation, modification or transformation is not very efficient and ultimately requires more time and resources on the part of the computer programmer. Furthermore, the source code may not always be available.

### SUMMARY

One or more embodiments, described herein, are directed towards a technology for performing transformations and/or modifications to managed byte code. In order to perform the transformations and/or modifications, a mutable programmable representation (MPR) is laid out. A programmer then performs an arbitrary adjustment using the MPR.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a high-level diagram of the transformational process.

FIG. 2 is an operational scenario for an operating system architecture that supports one or more implementations described herein.

FIG. 3 illustrates an environment where one or more transformations are performed utilizing the object model.

FIG. 4 is a flowchart of methodological implementation described herein.

### DETAILED DESCRIPTION

### Overview

The following description sets forth a new development of a transformational process of a managed compilation and execution sequence of a computer program. Utilizing this new transformational process, a programmer can efficiently analyze and understand a representation of complex intermediate code more cost-effectively. As a result, the programmer makes modifications and/or transformations to the intermediate code without having to understand the complexities associated with the actual structure of the intermediate code.

This new transformational process occurs after the generation of intermediate code, i.e. managed byte code, by a compiler. As previously mentioned, managed byte code is a low-level programming language that is “closer to the hardware.” Managed byte code is static code that does not provide a programmer with a simple structure that is easy to understand and analyze. In other words, it is very difficult for a programmer to directly interact with managed byte code in order to perform simple modifications and/or transformations to a computer program.

An example of managed byte code is “Common Intermediate Language” (CIL). CIL is an object-oriented assembly language. Because the Microsoft Corporation was an early adopter and developer of CIL, its intermediate language—which is often called “MSIL”—is a particular brand of CIL commonly employed in the industry.

Managed byte code further includes, for example, a collection of assemblies. An assembly is a piece of intermediate code. When a programmer groups one or more assemblies together in order to implement a single computer program, the managed byte code is referred to as managed assemblies. Thus, when focusing on a particular part of the computer program in order to add or remove program functionality for example, a programmer will modify, add or remove a single assembly to the computer program.

Managed byte code is difficult for a programmer to understand because it implements indirection to represent sharing separate elements of code and metadata included in the managed byte code. For example, each element of metadata included in managed byte code is located in a table and indices to the locations of these elements are used as values to represent the structure of a single assembly or group of assemblies.

Managed byte code is also difficult to understand because an intermediate language stream does not explicitly reflect all salient runtime behaviors. Intermediate language operation codes (opcodes), for example, may alter a programming stack. Additionally, certain kinds of metadata decorations, i.e. security attributes, can drastically alter the execution behavior of managed byte code. Thus, it is difficult for a programmer to understand implicit/runtime-dictated behavior of the managed byte code.

While managed byte code is highly desirable for the space efficiency of storing and transmitting one or more assemblies and is very portable, i.e. managed byte code has the ability to use a consistent byte code format that can be compiled and executed on multiple platforms, it is not useful for programmatic transformation of the one or more assemblies. The indirection makes it difficult and not cost effective for a programmer to analyze the structure of one or more assemblies in order to perform a simple transformation or modification to the managed byte code.

Note that static analysis tools and compilers need some degree of a representation of a program, but the representation is generally not mutable. Instead, the representation is either read-only, i.e. when analyzing or inspecting types, or is created at compile time. Furthermore, for reasons related to guaranteeing program correctness and avoiding security problems, a program's contents are almost never exposed in a programmable way.

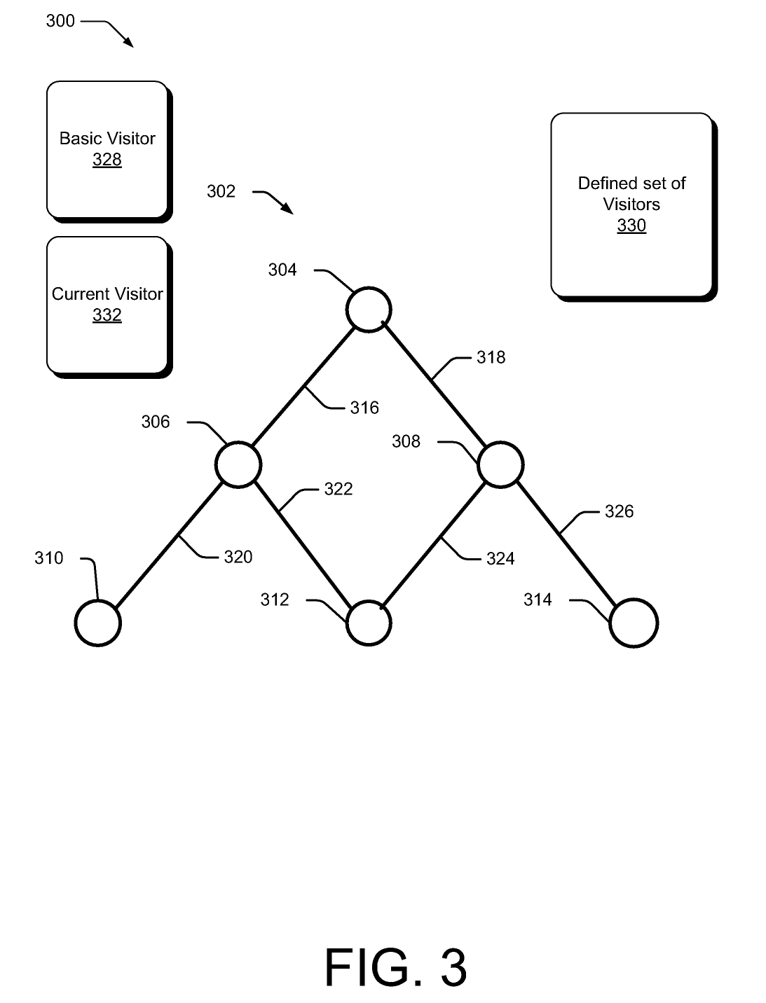

With the new transformational process, described herein, a programmer analyzes a computer program and performs a modification with ease and in a highly cost effective manner. This new transformational process reconstructs the managed byte code into a mutable programmable representation (MPR). The MPR is discussed in further detail below with respect to FIG. 3. Using the MPR, a programmer easily and arbitrarily performs a transformation and regenerates an output assembly (or assemblies) in accordance with the programmer's arbitrary transformation. Metadata, included in the managed byte code, can be easily added, removed or modified in a cost-effective manner. References to other code can be added, replaced or removed by the programmer easier than before.

Some non-limiting examples of possible transformations utilizing the MPR include: combining two or more assemblies into a single assembly, deconstructing one or more assemblies into distinct components, analyzing a body of reusable code components and subsequently removing all unused types and/or members, modifying all type and member visibilities to public to enable unit test scenarios, transformations in advance of shipping code to improve security, usability, performance etc.

Some specific non-limiting applications of the MPR include reordering well-defined sections of a method to be evaluated in the correct places, such as evaluating a post-condition right before all return paths in a method, or stitching together pre-conditions from a separate reference assembly.

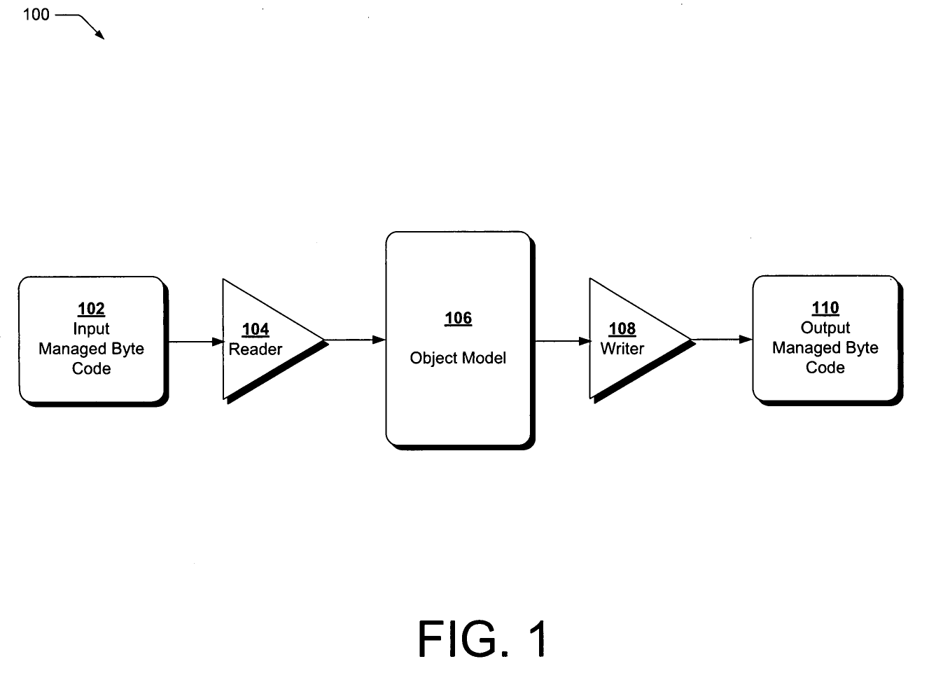

FIG. 1 illustrates a high-level diagram 100 of the transformational process of the described embodiment. The transformational process receives managed byte code 102 as input. The managed byte code has been generated by one or more compilers that target an intermediate language, such as CIL. In one embodiment, the managed byte code 102 input to the transformational process is one or more managed assemblies.

The managed byte code 102 is input to a reader 104 as a static representation of the one or more managed assemblies combined to make up the managed byte code. As such, it is highly normalized, i.e., no redundant information is stored. This static representation does not provide a programmer with a cost effective way of modifying or transforming the managed byte code because the structure of the managed byte code, with all the indirection, is difficult for the programmer to analyze and understand. There are many complexities and tedious details relating to the static representation of the managed byte that requires a lot of work or attention on the part of a programmer if the programmer would like to make a simple modification or transformation.

The reader 104 receives the managed byte code 102 and converts the managed byte code into the MPR, which is represented here as an object model 106. The reader 104 separates the managed byte code into separate elements. Separate elements that make-up the managed byte code, for example, include one or more metadata elements and one or more code elements. The one or more metadata elements describe the structure of one or more code elements in the managed byte code. The object model 106 provides a framework for programmers to directly interact with the separate elements of the metadata and code included in the managed byte code in order to perform modifications and transformations.

Additionally, the object model 106 provides a mechanism for programmers to directly interact with the execution behavior at runtime. This means that portions of the object model 106 capture detailed knowledge about specific runtime(s) in addition to understanding the elements of the managed byte code.

Utilizing the MPR, a programmer performs a modification or transformation to the managed byte code 102 input by writing minimal specifications implementing the desired modification or transformation. The object model 106 provides a structure that the programmer can understand and analyze more cost-effectively.

In other words, utilizing the object model 106, a programmer implements a modification or transformation to the managed byte code without having to perform in depth analysis of the managed byte code or without having to return to the source code and recompile the program. Thus, the modification or transformation is not performed in a compile-time environment. The object model 106 is discussed further below with respect to FIG. 3.

Next, a writer 108 converts the object model 106 from the MPR format back into one or more output managed assemblies 110.

### Exemplary Operating Environment

Before describing the object model and the transformational process in detail, the following discussion of an exemplary operating environment is provided to assist the reader in understanding one way in which various inventive aspects of the tools may be employed. The environment described below constitutes but one example and is not intended to limit application of the tools to any one particular operating environment. Other environments may be used without departing from the spirit and scope of the claimed subject matter.

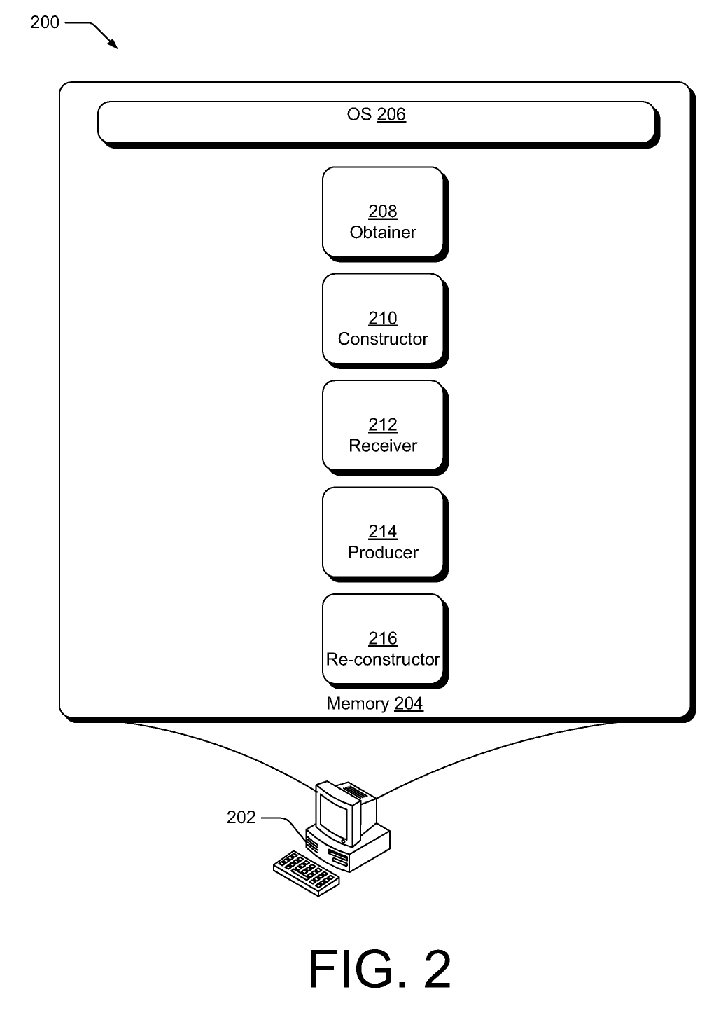

FIG. 2 is an exemplary operational environment configured to implement the new transformational process.

As depicted in FIG. 2, the exemplary operational environment 200 is implemented on a computer 202. The computer 202, for example, is configured as any computing device, such as a desktop computer, a server computer, a mobile station, a wireless phone and so forth. Computer 202 typically includes a variety of computer-readable media, including a memory 204. Such media may include any available media that are accessible by the computer 202 and include both volatile and non-volatile media, removable and non-removable media.

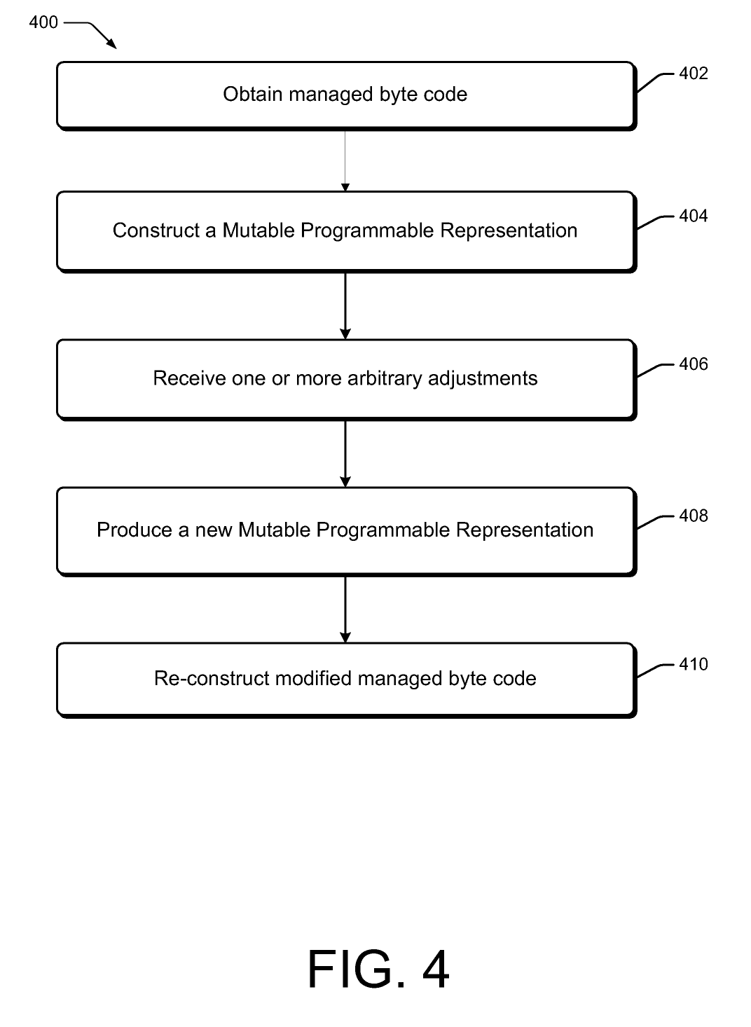

An operating system 206 is shown stored in the memory 204 and is executed on the computer 202. Also stored on the memory are software modules that implement the new transformational process. These software modules include an obtainer 208, a constructor 210, a receiver 212, a producer 214, and a re-constructor 216. These software modules are further defined below with respect to FIG. 4.

FIG. 3 illustrates an environment 300 where a transformation is performed utilizing the MPR, i.e. object model 302. As is consistent with one or more implementations described herein, the object model 302 is a completely faithful and accurate representation of the one or more managed assemblies (e.g., such as that which makes up the managed byte code 102) input to the transformational process. A completely faithful and accurate representation is one that accounts for every exact detail, i.e. every element of the code and metadata and their relationships, of the one or more managed assemblies. In other words, the object model 302 is a high fidelity representation of the code and metadata.

Typically, the managed byte code is a complicated graph that is difficult for a programmer to analyze, discern and transform. In contrast, the object model 302 is a hierarchal structure that is much easier for a programmer to understand in order to perform an arbitrary transformation.

The hierarchal structure is densely connected, so that all indirections associated with the managed byte code input to the transformational process are replaced with direct memory references in the object model 302 so that the hierarchal structure can be easily traversed.

Each instance of the object model 302 is a graph, the graph including one or more nodes (304, 306, 308, 310, 312, 314). Each node in the hierarchal structure corresponds to an element of the metadata and the code included in the managed byte code input to the transformational process. The object model 302 also includes direct links (316, 318, 320, 322, 324, 326) between two nodes. Each direct link represents the relationship between the two elements represented by each node connected by the direct link.

A programmer performs one or more transformations (i.e., modifications or adjustments), to the code and metadata laid out in the object model 302, by implementing a basic visitor 328. The basic visitor 328 is an extensible mechanism specifying transformations to the elements of the code and metadata laid out in the object model. This extensible mechanism lessens the amount of work that a programmer would have to do in order to realize a transformation.

The basic visitor 328, for example, is a programming class that includes one or more methods and one or more parameters. Thus, the extensible mechanism provides a rich infrastructure for arbitrary adjustments to the object model 302.

A visitor can be created for any arbitrary transformation of the MPR. The basic visitor 328 provides a default implementation for accessing and traversing the object model 302 and ease of extensibility when authoring a custom implementation of a visitor. The basic visitor 328 makes it extremely easy for a programmer to write a custom visitor because the default implementation of the basic visitor handles complicated steps of transforming and persisting the MPR.

By implementing a basic visitor 328, a programmer has the freedom and flexibility to arbitrarily adjust the elements of metadata and code laid out in the object model 302. In this sense, a programmer is not restricted to automatic, pre-defined transformations that are performed on particular elements of metadata and code.

However, any adjustments performed on the particular elements of the metadata and code must have runtime and static integrity. Thus, the transformational process provides verification that static and runtime integrity is preserved. For example, an exception is raised or an error is reported if one or more transformations compromise assembly integrity in any way, such as attempting to implement a transformation that does not function properly or compromises security.

Furthermore, the programmer is provided with a set of defined visitors 330 for simple transformations or filters over the elements of the metadata and code. A programmer utilizing the MPR will manually select one or more of the defined visitors 330 (i.e., arbitrary transformations) needed for a particular application and/or problem space.

The adjustments are called “arbitrary” because they are selected by a programmer to be performed on the object model 302. In other words, certain adjustments are not automatically, i.e. without user interaction, performed on particular elements of the metadata or code. Instead, for example, a programmer arbitrarily selects one of a variety of simple modifications to programmatically be performed on a particular piece of metadata or code.

Each of the defined visitors performs a common transformational task to the elements of code and metadata laid out in the object model 302. The set of defined visitors 330 is available to the programmer, so that the programmer can select one or more of the defined visitors 330, to be implemented as a current visitor 332 used to traverse the object model 302 and perform the one or more common transformational tasks on the code and metadata. Programmers utilize the set of defined visitors 330 to perform desired alterations and modifications to the managed byte code. Thus, the transformation is arbitrary based on the fact that a programmer manually selects a particular defined visitor from the set of defined visitors 330.

Common transformational tasks performed on the elements of the metadata and code include, but are not limited to static linking (combining) of assemblies, changing the visibility of elements, and instrumentation.

In another example, a programmer performs a transformation by writing programming code implementing the current visitor 332. In this scenario, the programmer utilizes the basic visitor's 328 default implementation and writes additional programming functionality from scratch in order to perform a particular transformation or modification.

Once a defined visitor is selected from the set of defined visitors 330, it becomes a current visitor 332 that traverses the object model 302. Current visitor 332 uses object-oriented sub-typing in order to perform the transformation on the object model 302. In other words, current visitor 332 is a subtype of the basic visitor 328. The basic visitor 328 has a separate method that is specific for the kind of element (code or metadata) it is applied to within the object model 302. However, the basic visitor 328 returns the most general type of element. Modifying the behavior of the basic visitor 328 is done by providing an override for the separate method so that the override is dynamically dispatched instead of the separate method in the basic visitor 328.

Thus, the current visitor 332, being a subtype, inherits all of the basic visitor's behavior, mainly visiting the elements laid out in the object model in order to implement desired modifications. However, at the same time, the current visitor 332 overrides the separate method of the basic visitor in order to implement the modification as selected by the programmer. In this scenario, a programmer performs a particular modification selected.

For example, in order to modify return statements found within each method in a given assembly, a programmer needs to select a current visitor 332 that overrides a basic visitor's method that specifically visits return statements within the object model 302. If the modification selected by the programmer is to replace return statements with some other kind of statement, the basic visitor's method for visiting return statements is overridden and is implemented to not return a return statement, but a general statement instead.

So a programmer utilizes one of a variety of visitors 330 in order to help implement a desired arbitrary transformation to the MPR of the managed byte code input to the reader. As a result the programmer only has to identify and focus on a particular transformation to a small piece of code as laid out in the object model 302.

Given an instance of the object model 302, current visitor 332 traverses each node (304, 306, 308, 310, 312, 314) in the assembly's graph and performs a desired modification to one or more nodes. As previously mentioned, the object model 302 is a hierarchal structure, utilizing direct links (316, 318, 320, 322, 324, 326) between each node. These direct links provide a framework for easily traversing the object model 302 in order to perform the desired modifications.

FIG. 4 is a flowchart describing an exemplary process 400 in which a programmer performs an arbitrary adjustment.

At 402, the obtainer 208 obtains managed byte code. In the high-level overview explained above in FIG. 1, managed byte code is input 102 to the reader 104. The managed byte code obtained is not limited to a complete computer program. For example, the transformational process can be performed on a selected set of managed byte code. Thus, the programmer can choose to focus on a single assembly or a variety of assemblies within the computer program. This provides a programmer with a flexible approach in performing a transformation to a particular part of a computer program.

At 404, the constructor 210 constructs the MPR from the managed byte code 102. This MPR is laid out in the object model as discussed above with respect to FIG. 3.

At 406, the receiver 212 receives an arbitrary transformation to the MPR. Such arbitrary adjustment is performed, for example, by a programmer when the programmer selects one of a variety of visitors as defined in the set of visitors 330. As opposed to an automatic transformation, which requires fixed, anticipated, and pre-defined conditions, the arbitrary transformation is not pre-set. Alternatively, a programmer may create/write a program to perform an arbitrary transformation utilizing the default implementation of the basic visitor 328.

In other words, a programmer is able to identify what element or elements, i.e. node(s), in the object model 302 for which an adjustment is desired, and then the programmer either writes a current visitor or utilizes one or more of the defined visitors in the set of defined visitors in order to implement the transformation.

Examples of arbitrary transformations include, but are not limited to combining two or more assemblies into a single assembly, deconstructing one or more assemblies into distinct components, analyzing a body of reusable code components and subsequently removing all unused types and/or members, modifying all type and member visibilities to public to enable unit test scenarios, transformations in advance of shipping code to improve security, usability, performance etc.

At 408, the producer 214 produces a new MPR. The new MPR incorporates a representation of the arbitrary transformation(s) performed by the programmer.

At 410, the re-constructor 216 re-constructs and outputs modified managed byte code from the new MPR. The writer 108 re-normalizes the new MPR into back a standard format for persisting the managed byte code, i.e. one or more assemblies. All of the indirections are re-introduced to replace the direct links between two nodes. The indirections depend upon the careful computation of the table indices so that the persisted assembly (or assemblies) can be consumed again by another tool to be used on the managed byte code.

### Conclusion

Although one or more embodiments have been described in language specific to structural features and/or methodological acts, it is to be understood that the appended claims are not necessarily limited to the specific features or acts described. Rather, the specific features and acts are described as exemplary forms of implementing the claimed embodiments.

1. One or more computer-readable storage media encoded with computer-executable instructions, that when executed by a processor of a computing device, configure the computing device to perform acts comprising:
obtaining managed byte code, wherein the managed byte code is a highly normalized, static representation of one or more valid managed assemblies;
constructing the managed byte code into a mutable programmable representation organized as a hierarchal object model that is completely faithful to the managed byte code;
receiving one or more arbitrary adjustments to the mutable programmable representation, wherein the one or more arbitrary adjustments are:
provided by a programmer; and
focused on a particular set of transformational tasks;
producing a new mutable programmable representation in response to the one or more arbitrary adjustments to the mutable programmable representation, wherein the new mutable programmable representation incorporates the one or more arbitrary adjustments; and
reconstructing modified managed byte code from the new mutable programmable representation, wherein the modified managed byte code is output in one or more assemblies.

2. A method comprising:
obtaining managed byte code;
constructing the managed byte code into a mutable programmable representation (MPR); and
receiving one or more arbitrary adjustments to the MPR.

3. A method as recited by claim 2 further comprising producing a new MPR in response to the receiving of one or more arbitrary adjustments to the MPR.

4. A method as recited by claim 3, wherein the new MPR incorporates a representation of the one or more arbitrary adjustments.

5. A method as recited by claim 3, further comprising re-constructing modified managed byte code from the new MPR, wherein the modified managed byte code is output in one or more assemblies.

6. A method as recited by claim 2, wherein the constructing and the receiving re-programs the managed byte code without access to a compile-time environment.

7. A method as recited by claim 2, wherein the one or more arbitrary adjustments are not automatically performed.

8. A method as recited by claim 2, wherein the MPR is organized as a hierarchal object model that is completely faithful to every element of the managed byte code.

9. A method as recited by claim 2 further comprising utilizing an extensible mechanism to perform the one or more arbitrary adjustments.

10. A method as recited by claim 2, wherein the one or more arbitrary adjustments are selected by a user.

11. A method as recited by claim 10, where the one or more arbitrary adjustments are selected from a plurality of arbitrary adjustments, the plurality of arbitrary adjustments corresponding to common programming transformational tasks.

12. A system comprising:
at least one processor; and
one or more computer-readable storage media, operatively coupled to the at least one processor, the one or more computer-readable storage media storing computer-executable instructions that, when executed, configure the system to perform actions comprising:
obtaining managed byte code;
constructing the managed byte code into a mutable programmable representation (MPR); and
receiving one or more arbitrary adjustments to the MPR.

13. A system as recited by claim 12, wherein the computer-executable instructions further configure the system to produce a new MPR in response to the receiving of one or more arbitrary adjustments to the MPR.

14. A system as recited by claim 13, wherein the new MPR incorporates a representation of the one or more arbitrary adjustments.

15. A system as recited by claim 12, wherein the computer-executable instructions further configure the system to re-construct modified managed byte code from the new MPR, wherein the modified managed byte code is output in one or more assemblies.

16. A system as recited by claim 12, wherein the one or more arbitrary adjustments are not automatically performed.

17. A system as recited by claim 12, wherein the MPR is organized as a hierarchal object model that is completely faithful to every element of the managed byte code.

18. A system as recited by claim 2, wherein the constructing and the receiving re-programs the managed byte code without access to a compile-time environment.

19. A system as recited by claim 12, wherein the one or more arbitrary adjustments are selected by a user.

20. A system as recited by claim 19, where the one or more arbitrary adjustments are selected from a plurality of arbitrary adjustments, the plurality of arbitrary adjustments corresponding to common programming transformational tasks.
